(19) United States
(12) Patent Application Publication
(10) Pub. No.: US 2023/0259959 A1
(43) Pub. Date: Aug. 17, 2023

(54) MULTI-TARGET PREDICTION METHOD AND APPARATUS, DEVICE, STORAGE MEDIUM AND PROGRAM PRODUCT

(71) Applicant: Tencent Technology (Shenzhen) Company Limited, Shenzhen (CN)

(72) Inventors: Yuwen FU, Shenzhen (CN); Liang CHEN, Shenzhen (CN)

(21) Appl. No.: 18/137,993

(22) Filed: Apr. 21, 2023

Related U.S. Application Data
(63) Continuation of application No. PCT/CN2022/104024, filed on Jul. 6, 2022.

(30) Foreign Application Priority Data
Aug. 9, 2021 (CN) 202110907940.9

(51) Int. Cl. G06Q 30/0202

(52) U.S. Cl. CPC G06Q 30/0202

(57) ABSTRACT

This application provides a multi-target event prediction method performed by a computer device. The method includes: obtaining a historical behavior code sequence according to a historical behavior data sequence of a target object. Prediction results of the predicted event associated with the target object are respectively obtained from dimensions of the various prediction targets on the basis of event information of the predicted event in combination with the historical feature data separately corresponding to the various prediction targets. Differences in the historical feature data of the target object between different prediction targets are considered during the obtaining of the prediction results, so that the obtained prediction results can reflect differences of the target object for the predicted event under the different prediction targets, thereby improving the accuracy and comprehensiveness of the prediction results.

### CROSS-REFERENCE TO RELATED APPLICATIONS

This application is a continuation application of PCT Patent Application No. PCT/CN2022/104024, entitled “MULTI-TARGET PREDICTION METHOD AND APPARATUS, DEVICE, STORAGE MEDIUM AND PROGRAM PRODUCT” filed on Jul. 6, 2022, which claims priority to Chinese Patent Application No. 202110907940.9, filed with the China National Intellectual Property Administration on Aug. 9, 2021, and entitled “MULTI-TARGET PREDICTION METHOD AND APPARATUS, DEVICE, STORAGE MEDIUM AND PROGRAM PRODUCT”, all of which is incorporated herein by reference in its entirety.

### FIELD OF THE TECHNOLOGY

Embodiments of this application relate to the field of computer and Internet technologies, and in particular, to multi-target prediction.

### BACKGROUND OF THE DISCLOSURE

At present, merchants will push relevant contents of the product to users when selling a product. In related technologies, before relevant contents of a product are pushed to a user, a historical behavior data sequence corresponding to the product is obtained, and a service effect of the user for the product is predicted in combination with user's own features.

However, in the above related technologies, when the historical behavior data sequence is directly used as a whole to predict the service effect, prediction results are inaccurate.

### SUMMARY

Embodiments of this application provide a multi-target event prediction method and apparatus, a device, a storage medium and a program product. Differences between different prediction targets are considered during obtaining of a prediction result, so that the accuracy of the prediction result is improved. The technical solutions are as follows:

According to one aspect of the embodiments of this application, a multi-target event prediction method is performed by a computer device, the method including:

obtaining a historical behavior code sequence according to a historical behavior data sequence of a target object;

generating, for each of a plurality of prediction targets, historical feature data of the target object associated with the prediction target according to correlations between the historical behavior code sequence and the prediction target;

receiving, from a terminal, a request for predicting an event associated with the target object, the request including event information of the predicted event;

obtaining, according to the event information of the predicted event and the historical feature data of the target object corresponding to the plurality of prediction targets, prediction results of the predicted event associated with the target object under the plurality of prediction targets; and

returning the prediction results of the predicted event associated with the target object to the terminal.

According to one aspect of the embodiments of this application, a multi-target event prediction apparatus is provided, including:

a code sequence obtaining module, configured to obtain a historical behavior code sequence according to a historical behavior data sequence of a target object; one historical behavior code in the historical behavior code sequence being a coded representation corresponding to one piece of historical behavior data in the historical behavior data sequence;

a feature data generation module, configured to generate, for each of a plurality of prediction targets, historical feature data of the target object associated with the prediction target according to correlations between various historical behavior codes in the historical behavior code sequence and the prediction target; and

a prediction result obtaining module, configured to obtain, according to event information of a predicted event and historical feature data separately corresponding to the various prediction targets, prediction results of the target object that separately correspond to the predicted event under the various prediction targets.

According to one aspect of the embodiments of this application, a computer device is provided, including a processor and a memory, the memory storing at least one instruction that, when executed by the processor, causes the computer device to implement the above multi-target event prediction method.

According to one aspect of the embodiments of this application, a non-transitory computer-readable storage medium is provided, storing at least one instruction, and the at least one instruction, when executed by a processor of a computer device, causing the computer device to implement the above multi-target event prediction method.

According to one aspect of the embodiments of this application, a computer program product or a computer program is provided. The computer program product or the computer program includes computer instructions stored in a computer-readable storage medium. A processor of a server reads the computer instructions from the computer-readable storage medium, and executes the computer instructions to cause the server to implement the above multi-target event prediction method.

The technical solutions provided in the embodiments of this application may include the following beneficial effects:

The historical feature data separately corresponding to the target object relative to different prediction targets is generated by using the correlations between the various historical behavior codes and the prediction targets. Since the correlations between the target object and different prediction targets are different, the historical feature data for the different prediction targets may also be different. Thus, prediction results of the target object correlated to the predicted event are respectively obtained from dimensions of the various prediction targets on the basis of event information of the predicted event in combination with the historical feature data separately corresponding to the various prediction targets. Differences in the historical feature data of the target object between different prediction targets are considered during the obtaining of the prediction results, so that the obtained prediction results can reflect differences of the target object for the predicted event under the different prediction targets, thereby improving the accuracy and comprehensiveness of the prediction results.

### BRIEF DESCRIPTION OF THE DRAWINGS

FIG. 1 is a schematic diagram of a multi-target prediction system according to one embodiment of this application.

FIG. 2 exemplarily shows a schematic diagram of a multi-target prediction system.

FIG. 3 is a flowchart of a multi-target event prediction method according to one embodiment of this application.

FIG. 4 exemplarily shows a schematic diagram of an obtaining manner of event feature data separately corresponding to various prediction targets.

FIG. 5 schematically shows a schematic diagram of an obtaining manner of a historical behavior embedding.

FIG. 6 schematically shows a schematic diagram of an obtaining manner of a historical behavior code sequence.

FIG. 7 exemplarily shows a schematic diagram of a flow of a multi-target prediction manner.

FIG. 8 is a block diagram of a multi-target prediction apparatus according to one embodiment of this application.

FIG. 9 is a block diagram of a multi-target prediction apparatus according to another embodiment of this application.

FIG. 10 is a schematic diagram of a structure of a server according to one embodiment of this application.

### DESCRIPTION OF EMBODIMENTS

To make the objectives, technical solutions, and advantages of this application clearer, the following further describes implementations of this application in detail with reference to the accompanying drawings.

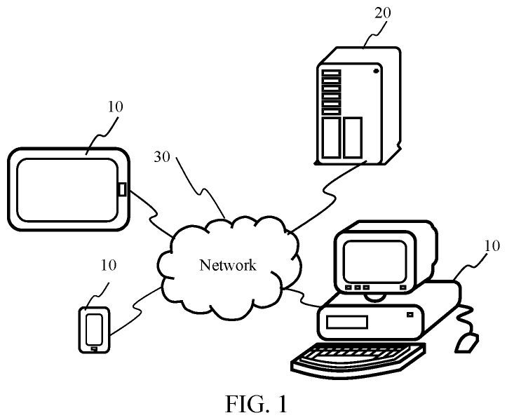

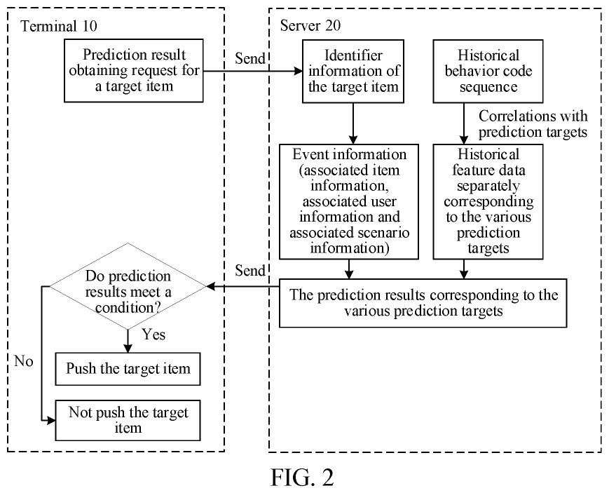

FIG. 1 shows a schematic diagram of a multi-target prediction system according to one embodiment of this application. The multi-target prediction system may include: a terminal 10 and a server 20.

The terminal 10 may be an electronic device such as a mobile phone, a tablet computer, a game console, an e-reader, a multimedia playback device, a wearable device, and a personal computer (PC). The terminal 10 may include a client of an application program. For example, the application program may be a shopping application program, a social application program, a game application program, a video application program, and the like. In some embodiments, the application program may be an application program needing to be downloaded and installed, or may be a click-to-run application program. This is not limited in this embodiment.

The server 20 is configured to provide a background service for the terminal 10. The server 20 may be one server, a server cluster including a plurality of servers, or a cloud computing service center. In some embodiments, the server 20 may be a back-end server of the above client. In an exemplary embodiment, the server 20 provides a background service for a plurality of terminals 10.

The terminal 10 may communicate with the server 20 by using a network 30.

In some embodiments, the above applications are those with item pushing functions. For example, the terminal 10 sends, to the server 20, a prediction result obtaining request for a target item. The prediction result obtaining request includes identifier information of the target item. Further, the server 20 determines the target item according to the identifier information of the target item, determines event information of a predicted event according to the target item, and obtains a historical behavior code sequence of the target object. The event information includes item-associated information, user-associated information and scenario-associated information. One historical behavior code in the historical behavior code sequence refers to a coded representation corresponding to one piece of historical behavior data in the historical behavior data sequence. The server 20 then obtains, according to correlations between various historical behavior codes in the historical behavior code sequence and a prediction target, historical feature data separately corresponding to various prediction targets, and obtains, according to the above event information in combination with the historical feature data separately corresponding to the various prediction targets, prediction results of the target object that separately correspond to the predicted event under the various prediction targets, so that the server 20 sends, to the terminal 10, the prediction results separately corresponding to the various prediction targets. Next, the terminal 10 determines to push the above target item to a user when the prediction results satisfy a condition. The target item is an associated item corresponding to the above event information.

In some embodiments, in this embodiment of this application, the server 20 is any server among multiple servers. The multiple servers may form a blockchain, and the servers are nodes on the blockchain, that is, the above server 20 is a node on the blockchain. In some embodiments, in this application, program instructions in the server are used for implementing the above multi-target event prediction method. As an example, the program instructions can be deployed and executed on one server, or executed on multiple servers located at one location, or executed on multiple servers distributed at multiple locations and interconnected by using a communication network. The multiple servers distributed at the multiple locations and interconnected by using the communication network can form a blockchain system.

It is understood that in specific implementations of this application, where relevant data such as historical behavior data is involved, when the above embodiments of this application are applied to a specific product or technology, it is necessary to obtain permissions or agreements of users for any applications, and the collection, use and processing of the relevant data are required to comply with the relevant laws, regulations and standards of relevant countries and districts.

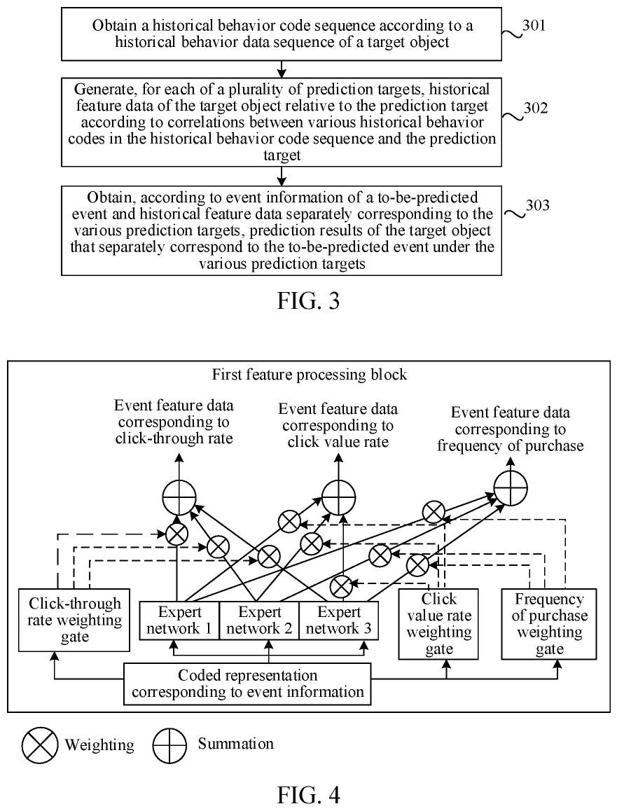

FIG. 3 shows a flowchart of a multi-target event prediction method according to one embodiment of this application. The method can be applied to the multi-target prediction system shown in FIG. 1. An executive body of all steps may be the server 20. The method may include several following steps (301 to 303):

Step 301. Obtain a historical behavior code sequence according to a historical behavior data sequence of a target object.

The historical behavior data sequence is used for reflecting operation behaviors of the target object for an item. The historical behavior data sequence includes a plurality of pieces of historical behavior data, and one piece of the historical behavior data corresponds to one operation behavior. In some embodiments, the operation behaviors refer to any of click, convert, search, collect, and the like. This is not limited in this embodiment. The above target object can be an object corresponding to any one or more user accounts, and the above item can be any one or more items.

The historical behavior code sequence refers to a coded representation corresponding to the historical behavior data sequence. One historical behavior code in the historical behavior code sequence is a coded representation corresponding to one piece of historical behavior data in the historical behavior data sequence.

In this embodiment of this application, the server obtains the historical behavior data sequence of the target object before obtaining prediction results, and then obtains the historical behavior code sequence according to the historical behavior data sequence. In some embodiments, the server codes various historical behavior data in the historical behavior data sequence respectively after obtaining the above historical behavior data sequence, to obtain the above historical behavior code sequence.

In some embodiments, in this embodiment of this application, each piece of historical behavior data includes a plurality of types of historical feature information. During the coding of the historical behavior data, the server codes the different types of historical feature information respectively, to obtain feature vectors separately corresponding to the various types, and then splices the feature vectors separately corresponding to the various types, to obtain historical behavior codes corresponding to the historical behavior data.

Step 302. Generate, for each of a plurality of prediction targets, historical feature data of the target object associated with the prediction target according to correlations between various historical behavior codes in the historical behavior code sequence and the prediction target.

The prediction target refers to an index parameter used for measuring an implementation effect of the predicted event. The predicted event can be any event, such as a sale event of goods, a conversion event of advertisements, an exposure event of videos, and the like. This is not limited in this embodiment. In some embodiments, one predicted event corresponds to one or more prediction targets. Moreover, prediction targets corresponding to different predicted events can be the same or different. For example, if the predicted event is a conversion event of an advertisement, the prediction target includes a click-through rate of the advertisement, a click value rate of the advertisement, and a purchase quantity of goods in the advertisement.

In this embodiment of this application, after obtaining the above historical behavior code sequence, the server generates, for each of the plurality of prediction targets, the historical feature data of the target object corresponding to the prediction target according to the correlations between the various historical behavior codes in the historical behavior code sequence and the prediction target. The above correlations are used for indicating associations between the historical behavior codes and the prediction target. The historical feature data of the target object corresponding to different prediction targets can be different.

In one possible implementation, the server obtains the above historical feature data through code filtering. In this case, the above associations are used for indicating whether the historical behavior codes are associated with the prediction target. In some embodiments, after obtaining the above historical behavior code sequence, the server selects, from the plurality of historical behavior codes according to correlations between a first prediction target and the various historical behavior codes, a historical behavior code associated with the first prediction target, and generates historical feature data corresponding to the first prediction target. At this time, the historical feature data corresponding to the first prediction target only includes the historical behavior code associated with the prediction target, which reduces a computation amount of subsequent data processing.

In another possible implementation, the server obtains the above historical feature data through weighting processing. In this case, the above associations are used for indicating an association degree between the historical behavior codes and the prediction target. In some embodiments, after obtaining the above historical behavior code sequence, the server determines, for a first prediction target among the plurality of prediction targets, the association degrees between the various historical behavior codes and the first prediction target according to correlations between the first prediction target and the various historical behavior codes, and then determines, according to the association degrees, weight parameters of the various historical behavior codes respectively for the first prediction target. The weight parameters have a positive correlation with the above association degrees. Next, the various historical behavior codes are separately weighted on the basis of the weight parameters separately corresponding to the various historical behavior codes, thereby generating historical feature data corresponding to the first prediction target. At this time, the historical feature data corresponding to the first prediction target includes a full historical behavior code, and different historical behavior codes correspond to different weight parameters, to improve the accuracy of subsequent data processing.

Of course, in other possible implements, the server can also obtain the above historical feature data through code filtering and weighting processing. In this case, the above associations are used for indicating an association degree between the historical behavior codes and the prediction target. In some embodiments, after obtaining the above historical behavior codes, the server obtains, for a first prediction target among the plurality of prediction targets, historical behavior codes associated with a first prediction target according to the association degrees between the various historical behavior codes and the first prediction target, obtains weight parameters separately corresponding to the various historical behavior codes associated with the first prediction target, and generates, by using the weighting processing, historical feature data corresponding to the first prediction target. At this time, the historical feature data corresponding to the first prediction target only includes the historical behavior codes associated with the prediction target, and different historical behavior codes correspond to different weight parameters.

Step 303. Obtain, according to event information of a predicted event and historical feature data separately corresponding to the various prediction targets, prediction results of the target object that separately correspond to the predicted event under the various prediction targets.

The event information is used for indicating feature data of the predicted event. In this embodiment of this application, after obtaining the historical feature data separately corresponding to the various prediction targets, the server obtains, according to the event information of the predicted event and the historical feature data separately corresponding to the various prediction targets, the prediction results of the target object corresponding to the predicted event under the various prediction targets.

In some embodiments, the above prediction results include a click-through rate, a click value rate and a purchase quantity. In an exemplary embodiment, after step 303, the method further includes following several sub-steps:

1. Obtain, according to the click-through rate and the click value rate, a click-through click value rate, for an associated item, of a user account corresponding to the event information, where the associated item is the target item above;

and/or,

2. Obtain a prediction result of purchase status of the user account for the associated item according to the click-through click value rate and the purchase quantity.

By specifying the prediction targets, this embodiment of this application can be applied to specific application scenarios to obtain the prediction results of a plurality of specific prediction target dimensions, which effectively improves the recommendation efficiency of the predicted event in terms of the click-through rate, the click value rate and the purchase quantity.

For example, assuming that the click-through rate is pCTR, the click value rate is pCVR, and the purchase quantity is n, the click-through click value rate is pCTCVR:

pCTCVR=pCTR*pCVR; and

the prediction result of purchase status P is:

P=pCTR*Pcvr*n.

In some embodiments, the above event information includes item-associated information, user-associated information and scenario-associated information. After obtaining the above event information, the server obtains the item-associated information according to the associated item corresponding to the event information; obtains the user-associated information according to the user account corresponding to the event information; and obtains the scenario-associated information. Later, the server obtains the above event information according to the item-associated information, the user-associated information and the scenario-associated information, and codes the event information to obtain a coded representation corresponding to the event information.

The above item-associated information includes a historical purchase status of the associated item. In some embodiments, the historical purchase status can be a historical purchase status of the user account for the associated item, or a historical purchase status of the target object for the associated item. This is not limited in this embodiment. The above purchase status includes but is not limited to at least one of the following: whether this item has been purchased, purchase time, a frequency of purchase, scenario information at the time of purchase, and the like. Of course, in an exemplary embodiment, the above item-associated information may also include but not limited to at least one of the following: identifier information of the associated item, a type of the associated item, a display platform of the associated item, a display position of the associated item, and the like.

The above user-associated information is used for reflecting account label information corresponding to the user account. The account label information can be drawn by the server according to various user data corresponding to the user account and is used for reflecting features of the user account. In some embodiments, the above user data includes but is not limited to at least one of the following: user's age corresponding to the user account, user's gender corresponding to the user account, a balance corresponding to the user account, and the like.

The above scenario-associated information is used for indicating an operation behavior occurrence environment. The operation behavior occurrence environment is a current scenario environment. In some embodiments, the scenario-associated information includes but is not limited to at least one of the following: a recent (today's, within a recent week, within a recent month, and the like) traffic of the display platform of the associated item, a recent trading volume of the display platform of the associated item, a recent market competitiveness of the display platform of associated item, and the like.

The event information of the predicted event can be represented comprehensively from multiple dimensions by obtaining the item-associated information, the user-associated information and the scenario-associated information, so that the coded representation of the event information can represent the predicted event more accurately, which helps to improve the accuracy of subsequent prediction results.

To sum up, in the technical solution provided in this embodiment of this application, the historical feature data separately corresponding to the target object relative to different prediction targets is generated by using the correlations between the various historical behavior codes and the prediction targets. Since the correlations between the target object and different prediction targets are different, the historical feature data for the different prediction targets may also be different. Thus, prediction results of the target object correlated to the predicted event are respectively obtained from dimensions of the various prediction targets on the basis of event information of the predicted event in combination with the historical feature data separately corresponding to the various prediction targets. Differences in the historical feature data of the target object between different prediction targets are considered during the obtaining of the prediction results, so that the obtained prediction results can reflect differences of the target object for the predicted event under the different prediction targets, thereby improving the accuracy and comprehensiveness of the prediction results.

An obtaining manner of the historical feature data will be described below.

In an exemplary embodiment, step 302 above includes following several steps:

1. Obtain operation behaviors separately corresponding to the various historical behavior codes in the historical behavior code sequence.

In this embodiment of this application, the server obtains the operation behaviors separately corresponding to the various historical behavior codes in the historical behavior code sequence when obtaining the above historical feature data.

2. Obtain, for each of the plurality of prediction targets, relevance respectively between the various operation behaviors and the prediction target.

In this embodiment of this application, the server obtains, for each of the plurality of prediction targets, the relevance respectively between the various operation behaviors and the prediction target after obtaining the operation behaviors separately corresponding to the above various historical behavior codes. In some embodiments, the relevance is used for quantitatively representing the above correlations.

In one possible implementation, the above relevance is used for indicating whether the operation behaviors are related to the prediction target. For example, if the operation behaviors are in correlation to the prediction target, the relevance between the historical behavior code and the prediction target is “1”. If operation behaviors are in no correlation to the prediction target, the relevance between the historical behavior code and the prediction target is “0”. Whether the operation behaviors are in correlation to the prediction target can be preset information. For example, if the prediction target is a click value rate, the related operation behaviors may be preset to include purchase and collect. If the prediction target is a click-through rate, the relevant operation behaviors may be preset to include click and search.

In another possible implementation, the above relevance is used for indicating association degrees between the operation behaviors and the prediction target. For example, if the operation behaviors are in strong correlation to the prediction target, the relevance between the historical behavior code and the prediction target is “1”. If operation behaviors are in intermediate correlation to the prediction target, the relevance between the historical behavior code and the prediction target is “0.5”. If operation behaviors are in weak correlation to the prediction target, the relevance between the historical behavior code and the prediction target is “0.1”. The association degrees between the operation behaviors and the prediction target can be preset information. For example, if the prediction target is a click value rate, the relevant operation behaviors may be preset to include purchase (the relevance is 1), collect (the relevance is 0.5), click (the relevance is 0.3), and search (the relevance is 0.1). If the prediction target is a click-through rate, the relevant operation behaviors may be preset to include click (the relevance is 1) and search (the relevance is 0.3).

3. Weight the various historical behavior codes according to the relevance between the various operation behaviors and the prediction target, to obtain the historical feature data of the target object associated with the prediction target.

In this embodiment of the present application, after obtaining the above relevance, the server weights the various historical behavior codes according to the relevance between the various operation behaviors and the prediction target, to obtain the historical feature data corresponding to the prediction target. By refining a dimension, namely, the operation behavior, to determine the relevance between the historical behavior codes and the prediction target, the ability of representing the operation behaviors by the historical feature data can be effectively improved, and the association degrees with the operation behaviors can be highlighted, which improves the accuracy of the historical feature data.

In some embodiments, the server respectively obtains similarities between the various historical behavior codes and the coded representation corresponding to the event information; further, determines, according to the relevance and the similarities separately corresponding to the various historical behavior codes, weight parameters separately corresponding to the various historical behavior codes; and then weights the various historical behavior codes according to the weight parameters separately corresponding to the various historical behavior codes, to obtain the historical feature data corresponding to the prediction target.

Due to differences in the association degrees between different operation behaviors and the event information used for representing the predicted event, in order to improve the accuracy of subsequent determination of the prediction results, the similarities between the historical behavior codes and the event information can be determined in advance during the determination of the historical feature data of the target object corresponding to different prediction targets, so as to obtain more accurate historical feature data.

The above weight parameters have a positive correlation with the above relevance, that is, a larger relevance indicates a larger weight parameter. In addition, the above weight parameters are also in position correlation with the above similarities, that is, a higher similarity indicates a larger weight parameter.

In some embodiments, the above association degree and the above similarity are both expressed in the form of specific values, and the relevance is in positive correlation with a value, and the similarity degree is also in positive correlation with a value. In some embodiments, the server obtains the above weight parameters by using products between the relevance and the similarities. In one possible implementation, the server directly uses the products as the weight parameters. In another possible implementation, after obtaining the above products, the server performs normalization processing on the products to obtain the above weight parameters.

Of course, in an exemplary embodiment, the above relevance and the above similarity can also be expressed in other forms. This is not limited in this embodiment. For example, expression forms of the relevance include extremely high relevance, high relevance, intermediate relevance, weak relevance, extremely weak relevance, no relevance, and the like. Expression forms of the similarity include extremely high similarity, high similarity, intermediate similarity, weak similarity, extremely weak similarity, no similarity, and the like. In some embodiments, after obtaining the above relevance and the above similarities, the server determines importance of the various historical behavior codes for the prediction target on the basis of the relevance and the similarities, and then determines the weight parameters separately corresponding to the various historical behavior codes according to the importance. The weight parameters have a positive correlation with the above importance.

In some embodiments, when the above relevance and the above similarity are both expressed in the form of specific values, a product between the relevance and the similarity can be used for representing the above association. In one possible implementation, the above products are directly used for representing the above association degrees. In another possible implementation, after the above products are obtained, historical behavior codes with a product greater than a certain value are determined as the historical behavior codes associated with the prediction target. The value can be any value. This is not limited in this embodiment.

An obtaining manner of the prediction result is described below.

In an exemplary embodiment, step 303 above includes following several steps:

1. Extract, on the basis of the event information, event feature data separately corresponding to the various prediction targets.

In this embodiment of this application, during the obtaining of the above prediction results, the server extracts, on the basis of the event information, event feature data separately corresponding to the various prediction targets.

In some embodiments, the server obtains the coded representation corresponding to the event information, and performs feature extraction processing on the coded representation respectively by using different expert networks, to obtain a feature extraction result set. The feature extraction result set includes feature extraction results from the different expert networks. Further, the server obtains a plurality of groups of weighted parameters for the feature extraction result set by respectively using different weighting gates. Each group of weighted parameters includes weighted parameters separately corresponding to the various feature extraction results in the feature extraction result set, and the weighting gates and the prediction targets have a one-to-one correspondence relation. Then, the server performs, for each prediction target, weighted summation processing on the various feature extraction results in the feature extraction result set on the basis of one of the plurality of groups of weighted parameters corresponding to the prediction target, to obtain event feature data corresponding to the prediction target.

For example, assuming that the prediction targets include the click-through rate, the click value rate and the purchase quantity, as shown in FIG. 4, after obtaining the coded representation corresponding to the event information, the server uses expert network 1, expert network 2 and expert network 3 to respectively perform the feature extraction processing on the coded representation, to obtain the feature extraction results from the different expert networks. Furthermore, a click-through rate weighting gate determines, on the basis of the above coded representation, first weighted parameters separately corresponding to the various feature extraction results; a click value rate weighting gate determines, on the basis of the above coded representation, second weighted parameters separately corresponding to the various feature extraction results; and a frequency of purchase weighting gate determines, on the basis of the above coded representation, third weighted parameters separately corresponding to the various feature extraction results. Then, the server performs weighted summation processing respectively on the various feature extraction results according to a first weighted parameter group, a second weighted parameter group and a third weighted parameter group, to obtain the event feature data separately corresponding to the various prediction targets.

The essence of the event information can be comprehensively represented by using the feature extraction result set composed of the feature extraction results separately provided by the different expert networks for the event information, thereby improving the accuracy of the event information and the accuracy of the event feature data separately corresponding to the various prediction targets.

2. Obtain, for each prediction target according to the historical feature data corresponding to the prediction target and the event feature data corresponding to the prediction target, a prediction result of the target object that corresponds to the predicted event under the prediction target.

In this embodiment of this application, after obtaining the event feature data separately corresponding to the various prediction targets, the server obtains, for each prediction target according to the historical feature data corresponding to the prediction target and the event feature data corresponding to the prediction target, the prediction result corresponding to the prediction target.

That is, during the determination of the prediction results between the target object and the predicted event, a relation between the target object and the predicted event needs to be considered, and a relation between the predicted event and the prediction target can be further referred to. By introducing the event feature data, the above referred relation between the predicted event and the prediction target can be effectively represented, so as to achieve the accuracy of the prediction result.

In some embodiments, the server fuses, for each prediction target, the historical feature data corresponding to the prediction target with the event feature data corresponding to the prediction target, to obtain fused feature data corresponding to the prediction target; and further, generates, according to the fused feature data by using a prediction network corresponding to the prediction target, the prediction result corresponding to the prediction target. For example, the above prediction network is a Tower network.

By fusing the historical feature data with the event feature data, information between the historical feature data and the event feature data can be more comprehensively shared during the determination of the prediction result based on the fused feature data, which improves the accuracy of the prediction result.

An obtaining manner of the historical behavior code sequence will be described below.

1. Obtain a historical behavior embedding sequence according to the historical behavior data sequence.

In this embodiment of this application, when obtaining the above historical behavior code sequence, the server first obtains the historical behavior data sequence, and then obtains historical behavior embedding vectors according to the historical behavior data sequence. In some embodiments, the above historical behavior data sequence is a data sequence correlated to the above event information. When obtaining the historical behavior data sequence, the server obtains the historical behavior data sequence on the basis of the above event information.

In one possible implementation, the server obtains the historical behavior data sequence on the basis of the user account corresponding to the event information. In some embodiments, when obtaining the historical behavior data sequence, the server obtains the user account corresponding to the above event information, and then determines the target object according to the user account. In some embodiments, the target object includes the user account and/or a similar user account. The similar user account and the user account have similar user features. In some embodiments, the similar user features include but are not limited to at least one of the following: an age difference between users is less than a first target value; users' genders are the same; the users have purchased similar items, a difference between quantities of similar items that have been purchased by the users is less than the second target value; the users have viewed similar videos; and the like.

In another possible implementation, the server obtains the historical behavior data on the basis of the target item corresponding to the event information. In some embodiments, when obtaining the historical behavior data sequence, the server obtains the target item corresponding to the above event information, and then determines, according to the target item, an item targeted by the historical behavior data. In some embodiments, this item includes the target item and/or a similar item. The similar item and the target item have similar item features. In some embodiments, the similar item features include but are not limited to at least one of the following: items are of a same type; item display platforms are the same; user groups targeted by items are the same; and the like.

Of course, in other possible implementations, the server can also obtain the above historical behavior data sequence by taking the user account corresponding to the event information and the target item as constraint conditions. For example, the server determines the above target object according to the user account, and then obtains, by taking the full historical behavior data corresponding to the target object as a range, the historical behavior data corresponding to the item indicated by the target item, and generates the above historical behavior data sequence.

One historical behavior embedding in the historical behavior embedding sequence is an embedding representation corresponding to one piece of historical behavior data in the historical behavior data sequence. In some embodiments, each piece of historical behavior data includes historical item information, historical behavior information and historical scenario information. When obtaining the historical behavior embedding sequence, the server obtains a first feature vector, a second feature vector and a third feature vector for each piece of historical behavior data in the historical behavior data sequence. The first feature vector refers to a feature vector corresponding to the historical item information; the second feature vector refers to a feature vector corresponding to the historical behavior information; and the third feature vector refers to a feature vector corresponding to the historical scenario information. Next, the server splices the first feature vectors, the second feature vectors and third feature vectors corresponding to the various historical behavior data, to obtain the historical behavior embedding sequence.

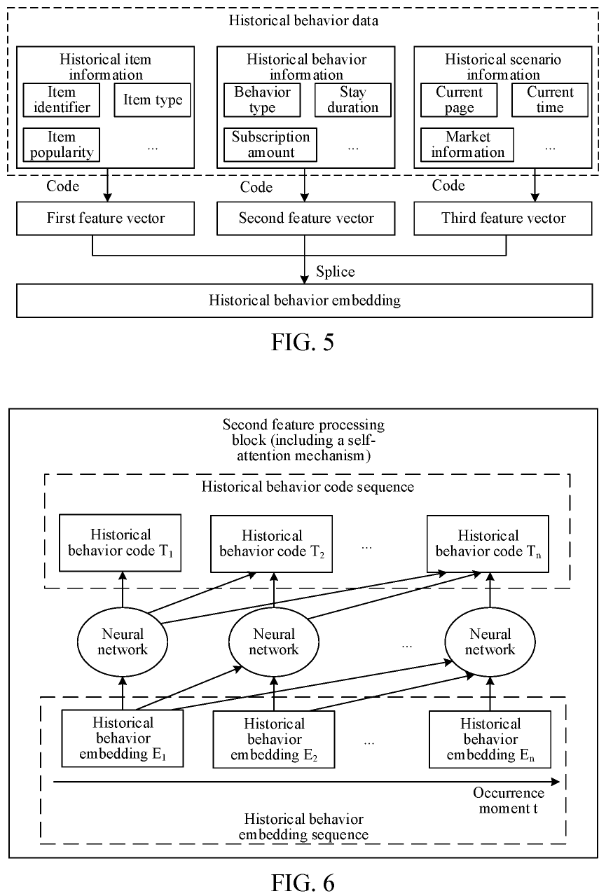

For example, as shown in FIG. 5, the historical behavior data includes historical item information, historical behavior information and historical scenario information. The historical item information includes but is not limited to at least one of the following: item identifiers, item types, item popularity, and the like. The historical behavior information includes but is not limited to at least one of the following: behavior types, stay durations, subscription amounts, and the like. The historical scenario information includes but is not limited to at least one of the following: current pages, current time, market information, and the like. After obtaining the above historical behavior data, the server codes the historical item information, the historical behavior information and the historical scenario information respectively, to obtain the first feature vector, the second feature vector and the third feature vector, and then splice the first feature vector, the second feature vector and the third feature vector, to obtain the historical behavior embedding corresponding to the above historical behavior data.

The feature vectors corresponding to the historical behavior data are determined from multiple dimensions: items, scenarios and behaviors, so that the feature vectors for representing the foregoing different dimensions are spliced to obtain the historical behavior embedding, which has a more comprehensive representation ability.

2. Code the various historical behavior embedding in the historical behavior embedding sequence respectively, to obtain the historical behavior code sequence.

In this embodiment of this application, the server codes various historical embedding in the historical behavior embedding sequence respectively after obtaining the above historical behavior embedding sequence, to obtain the above historical behavior code sequence.

The historical behavior embedding is coded to obtain the historical behavior codes, so that a data volume can be effectively reduced while the representation precision is guaranteed, thereby saving resources for subsequent processing.

In some embodiments, the server obtains, for each historical behavior embedding in the historical behavior embedding sequence, at least one preceding historical behavior embedding according to an occurrence moment of an operation behavior corresponding to the historical behavior embedding. An occurrence moment of an operation behavior corresponding to the preceding historical behavior embedding is before the occurrence moment of the operation behavior corresponding to the historical behavior embedding. Next, the server codes the various historical behavior embedding and the at least one preceding historical behavior embedding corresponding to the historical behavior embedding respectively, to obtain the historical behavior code sequence.

For example, as shown in FIG. 6, the historical behavior embedding sequence includes historical behavior embedding E₁, historical behavior embedding E₂, . . . , historical behavior embedding Eₙ, and the occurrence moment of historical behavior embedding E₁ is the earliest, and the occurrence moment of historical behavior embedding Eₙ is the latest. After obtaining the historical behavior embedding sequence, the server obtains, for each historical behavior embedding at least one preceding historical behavior embedding according to the occurrence moment of the historical behavior embedding, and respectively codes the various historical behavior embedding and at least one preceding historical behavior embedding corresponding to the historical behavior embedding by using a neural network, to obtain the historical behavior code sequence. The historical behavior code sequence includes historical behavior code T₁, historical behavior code T₂, . . . , historical behavior code Tₙ.

The preceding historical behavior embedding before the historical behavior embedding can be obtained by using the occurrence moment of the operation behavior, and the preceding historical behavior embedding is used in the coding of the historical behavior embedding, which is equivalent to integrating a previous operation behavior into the historical behavior code, equivalent to integrating preceding information, thus adding temporal-dimension information in the historical behavior code and expanding an observation field of view corresponding to the historical behavior code.

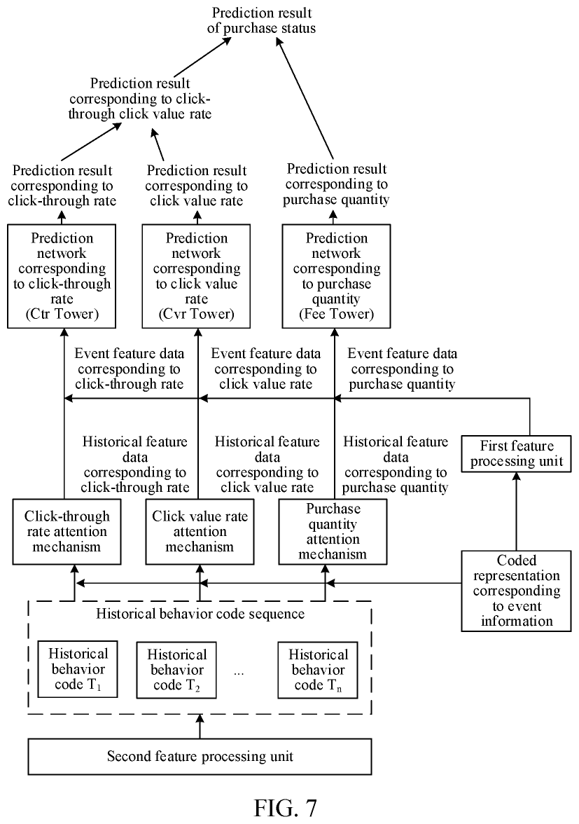

In addition, assuming that the above prediction targets include a click-through rate, a click value rate and a purchase quantity, referring to FIG. 7, a complete multi-target event prediction method of this application is described. In the server, the historical behavior code sequence is obtained from a second feature processing block shown in FIG. 6. The second feature processing block includes a self-attention mechanism. A first feature processing block shown in FIG. 4 obtains the event feature data corresponding to the click-through rate, the event feature data corresponding to the click value rate, and the event feature data corresponding to the purchase quantity by using the coded representation corresponding to the event information. Moreover, after the historical behavior code sequence is obtained, the historical feature data corresponding to the click-through rate is obtained by using a click-through rate attention mechanism and combining the coded representation corresponding to the event information; the historical feature data corresponding to the click value rate is obtained by using a click value rate attention mechanism and combining the coded representation corresponding to the event information; and the historical feature data corresponding to the purchase quantity is obtained by using a purchase quantity attention mechanism and combining the coded representation corresponding to the event information. According to the historical feature data corresponding to the click-through rate and the event feature data corresponding to the click-through rate, the server then obtains, by using a prediction network corresponding to the click-through rate, a prediction result corresponding to the click-through rate. According to the historical feature data corresponding to the click value rate and the event feature data corresponding to the click value rate, the server then obtains, by using a prediction network corresponding to the click value rate, a prediction result corresponding to the click value rate. According to the historical feature data corresponding to the purchase quantity and the event feature data corresponding to the purchase quantity, the server then obtains, by using a prediction network corresponding to the purchase quantity, a prediction result corresponding to the purchase quantity. Finally, according to the prediction result corresponding to the click-through rate and the prediction result corresponding to the click value rate, the server can obtain a prediction result corresponding to a click-through click value rate. In addition, a prediction result of purchase status is obtained according to the prediction result corresponding to the click-through click value rate and the prediction result corresponding to the purchase quantity.

The following describes an apparatus embodiment of this application, which can be configured to implement the method embodiment of this application. For details not disclosed in the apparatus embodiment of this application, refer to the method embodiment of this application.

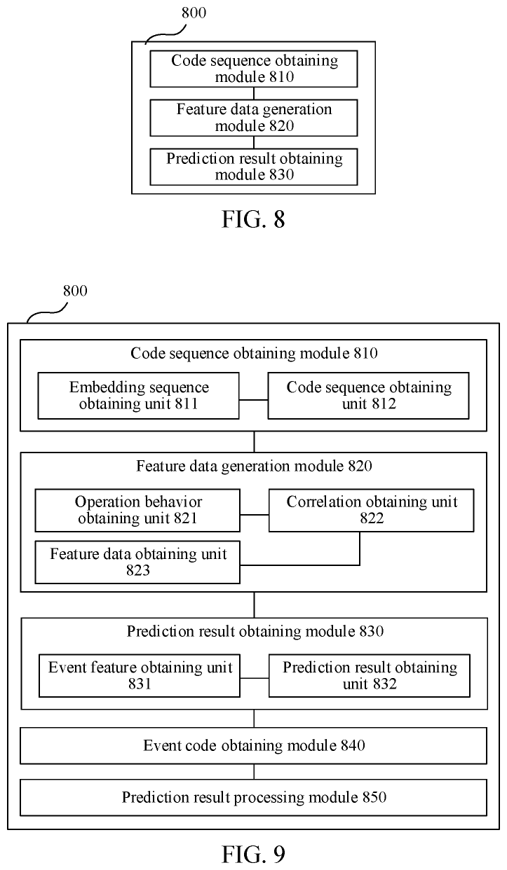

FIG. 8 shows a block diagram of a multi-target prediction apparatus according to one embodiment of this application. The apparatus has a function of implementing the foregoing multi-target event prediction method. The function may be realized by hardware or may be realized by executing corresponding software by hardware. The apparatus may be a server, or may be arranged in the server. The apparatus 800 may include: a code sequence obtaining module 810, a feature data generation module 820 and a prediction result obtaining module 830.

The code sequence obtaining module 810 is configured to obtain a historical behavior code sequence according to a historical behavior data sequence of a target object; one historical behavior code in the historical behavior code sequence being a coded representation corresponding to one piece of historical behavior data in the historical behavior data sequence.

The feature data generation module 820 is configured to generate, for each of a plurality of prediction targets, historical feature data of the target object associated with the prediction target according to correlations between various historical behavior codes in the historical behavior code sequence and the prediction target.

The prediction result obtaining module 830 is configured to obtain, according to event information of a predicted event and historical feature data separately corresponding to the various prediction targets, prediction results of the target object that separately correspond to the predicted event under the various prediction targets.

In an exemplary embodiment, as shown in FIG. 9, the feature data generation module 820 includes: an operation behavior obtaining unit 821, a correlation obtaining unit 822 and a feature data obtaining unit 823.

The operation behavior obtaining unit 821 is configured to obtain operation behaviors separately corresponding to the various historical behavior codes in the historical behavior code sequence.

The correlation obtaining unit 822 is configured to obtain, for each of the plurality of prediction targets, relevance respectively between the various operation behaviors and the prediction target, the relevance being used for quantitatively representing the correlations.

The feature data obtaining unit 823 is configured to weight the various historical behavior codes according to the relevance between the various operation behaviors and the prediction target, to obtain the historical feature data of the target object associated with the prediction target.

In an exemplary embodiment, the feature data obtaining unit 823 is configured to respectively obtain similarities between the various historical behavior codes and a coded representation corresponding to the event information; determine, according to the relevance and the similarities separately corresponding to the various historical behavior codes, weight parameters separately corresponding to the various historical behavior codes; and weight the various historical behavior codes according to the weight parameters separately corresponding to the various historical behavior codes, to obtain the historical feature data corresponding to the prediction target.

In an exemplary embodiment, as shown in FIG. 9, the prediction result obtaining module 830 includes: an event feature obtaining unit 831 and a prediction result obtaining unit 832.

The event feature obtaining unit 831 is configured to extract, on the basis of the event information, event feature data separately corresponding to the various prediction targets.

The prediction result obtaining unit 832 is configured to obtain, for each prediction target according to the historical feature data corresponding to the prediction target and the event feature data corresponding to the prediction target, a prediction result of the target object that corresponds to the predicted event under the prediction target.

In an exemplary embodiment, the event feature obtaining unit 831 is configured to: obtain a coded representation corresponding to the event information; perform feature extraction processing on the coded representation respectively by using different expert networks, to obtain a feature extraction result set, where the feature extraction result set includes feature extraction results from the different expert networks; obtain a plurality of groups of weighted parameters for the feature extraction result set by respectively using different weighting gates, where each group of weighted parameters includes weighted parameters separately corresponding to the various feature extraction results in the feature extraction result set, and the weighting gates and the prediction targets have a one-to-one correspondence relation; and perform, for each prediction target, weighted summation processing on the various feature extraction results in the feature extraction result set on the basis of one of the plurality of groups of weighted parameters corresponding to the prediction target, to obtain event feature data corresponding to the prediction target.

In an exemplary embodiment, the prediction result obtaining unit 832 is configured to: fuse, for each prediction target, the historical feature data corresponding to the prediction target with the event feature data corresponding to the prediction target, to obtain fused feature data corresponding to the prediction target; and generate, according to the fused feature data by using a prediction network corresponding to the prediction target, the prediction results of the target object separately corresponding to the predicted event under the various prediction targets.

In an exemplary embodiment, as shown in FIG. 9, the code sequence obtaining module 810 includes: an embedding sequence obtaining unit 811 and a code sequence obtaining unit 812.

The embedding sequence obtaining unit 811 is configured to obtain a historical behavior embedding sequence according to the historical behavior data sequence; one historical behavior embedding in the historical behavior embedding sequence being an embedding representation corresponding to one piece of historical behavior data in the historical behavior data sequence.

The code sequence obtaining unit 812 is configured to code the various historical behavior embedding in the historical behavior embedding sequence respectively, to obtain the historical behavior code sequence.

In an exemplary embodiment, the code sequence obtaining unit 812 is configured to: obtain, for each historical behavior embedding in the historical behavior embedding sequence, at least one preceding historical behavior embedding according to an occurrence moment of an operation behavior corresponding to the historical behavior embedding, where an occurrence moment of an operation behavior corresponding to the preceding historical behavior embedding is before the occurrence moment of the operation behavior corresponding to the historical behavior embedding; and code the various historical behavior embedding and the at least one preceding historical behavior embedding corresponding to the historical behavior embedding respectively, to obtain the historical behavior code sequence.

In an exemplary embodiment, each piece of historical behavior data includes historical item information, historical behavior information and historical scenario information. The embedding sequence obtaining unit 811 is configured to: obtain a first feature vector, a second feature vector and a third feature vector for each piece of historical behavior data in the historical behavior data sequence, where the first feature vector refers to a feature vector corresponding to the historical item information; the second feature vector refers to a feature vector corresponding to the historical behavior information; and the third feature vector refers to a feature vector corresponding to the historical scenario information; and splice the first feature vectors, the second feature vectors and third feature vectors corresponding to the various historical behavior data, to obtain the historical behavior embedding sequence.

In an exemplary embodiment, the event information includes item-associated information, user-associated information and scenario-associated information. As shown in FIG. 9, the apparatus 800 further includes: an event code obtaining module 840.

The event code obtaining module 840 is configured to: obtain the item-associated information according to an associated item corresponding to the event information, the item-associated information including a historical purchase status of the associated item; obtain the user-associated information according to a user account corresponding to the event information, the user-associated information being used for reflecting account label information corresponding to the user account; obtain the scenario-associated information, the scenario-associated information being used for indicating an operation behavior occurrence environment; obtain the event information according to the item-associated information, the user-associated information and the scenario-associated information; and code the event information to obtain a coded representation corresponding to the event information.

In an exemplary embodiment, the prediction results include a click-through rate, a click value rate and a purchase quantity. As shown in FIG. 9, the apparatus 800 further includes: a prediction result processing module 850.

The prediction result processing module 850 is configured to: obtain, according to the click-through rate and the click value rate, a click-through click value rate, for the associated item, of the user account corresponding to the event information; and/or, obtain a prediction result of purchase status of the user account for the associated item according to the click-through click value rate and the purchase quantity.

To sum up, in the technical solution provided in this embodiment of this application, the historical feature data corresponding to the prediction targets is generated by using the correlations between the various historical behavior codes and the prediction targets, so that the prediction results separately corresponding to the various prediction targets are respectively obtained on the basis of the event information of the predicted event by combining the historical feature data separately corresponding to the various prediction targets. During the obtaining of the prediction results, differences between different prediction targets are considered. The prediction results are obtained for different prediction targets according to different historical feature data, which improves the accuracy of the prediction results.

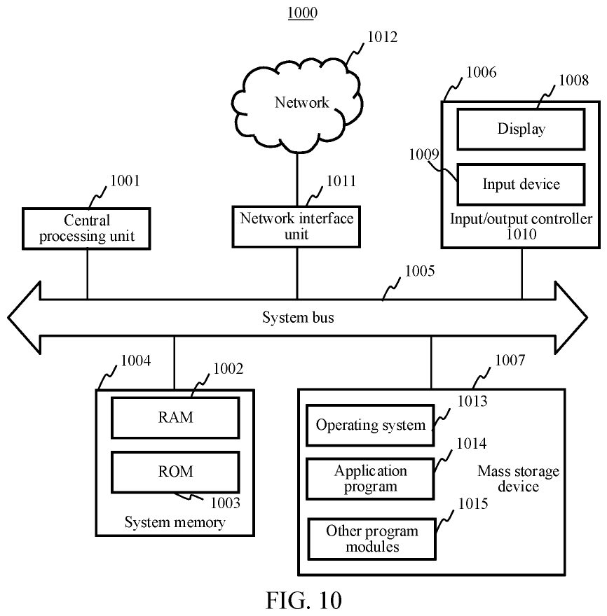

FIG. 10 shows a structural block diagram of a server according to one embodiment of this application. The server can be configured to realize the functions of the above multi-target event prediction method. Specifically:

The server 1000 includes a Central Processing Unit (CPU) 1001, a system memory 1004 including a Random Access Memory (RAM) 1002 and a Read Only Memory (ROM) 1003, and a system bus 1005 for connecting the system memory 1004 to the CPU 1001. The server 1000 further includes a basic input/output (I/O) system 1006 helping transmit information between components in a computer, and a mass storage device 1007 configured to store an operating system 1013, an application program 1014, and another program module 1015.

The basic I/O system 1006 includes a display 1008 configured to display information and an input device 1009, such as a mouse or a keyboard, configured to input information by a user. The display 1008 and the input device 1009 are both connected to the CPU 1001 by using an I/O controller 1010 that is connected to the system bus 1005. The basic I/O system 1006 may further include the I/O controller 1010 configured to receive and process inputs from a plurality of other devices such as a keyboard, a mouse, and an electronic stylus. Similarly, the I/O controller 1010 further provides an output to a display screen, a printer, or another type of output device.

The mass storage device 1007 is connected to the CPU 1001 through a mass storage controller (not shown) connected to the system bus 1005. The mass storage device 1007 and its associated computer-readable media provide non-volatile storage for the server 1000.

Generally, the computer-readable media may include computer storage media and communication media. The computer storage media include volatile and nonvolatile, removable and non-removable media implemented in any method or technology for storage of information such as computer-readable instructions, data structures, program modules or other data. The computer storage medium includes a RAM, a read only memory (ROM), an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Of course, those skilled in the art will appreciate that the computer storage media are not limited to the foregoing. The system memory 1004 and the mass storage device 1007 described above may be referred to collectively as memory.

According to various embodiments of this application, the server 1000 may further be connected, by using a network such as the Internet, to a remote computer on the network and run. That is, the server 1000 may be connected to the network 1012 through a network interface unit 1011 connected to the system bus 1005, or may be connected to other types of networks or remote computer systems (not shown) using the network interface unit 1011.

The memory further includes a computer program. The computer program is stored in the memory and configured to be executed by one or more processors, to implement the above multi-target event prediction method.

In an exemplary embodiment, a non-transitory computer-readable storage medium is further provided. The storage medium stores at least one instruction, at least one section of program, and a code set or an instruction set, and the at least one instruction, the at least one section of program, and the code set or the instruction set are loaded and executed by a processor to implement the above multi-target event prediction method.

In some embodiments, the computer-readable storage medium may include: a ROM, a RAM, a solid state drive (SSD), an optical disc, or the like. The RAM may include a resistance random access memory (ReRAM) and a dynamic random access memory (DRAM).

In an exemplary embodiment, a computer program product or a computer program is provided, the computer program product or the computer program including computer instructions stored in a non-transitory computer-readable storage medium. A processor of a server reads the computer instructions from the computer-readable storage medium, and executes the computer instructions to cause the server to implement the above multi-target event prediction method.

“Plurality of” mentioned herein means two or more. “And/or” describes an association relation for associated objects and represents that three relationships may exist. For example, A and/or B may represent: only A exists, both A and B exist, and only B exists. The character “/” usually indicates an “or” relation between associated objects. In addition, the step numbers described in this specification merely exemplarily show a possible execution sequence of the steps. In some other embodiments, the above steps may not be performed according to the number sequence. For example, two steps with different numbers may be performed simultaneously, or two steps with different numbers may be performed according to a sequence contrary to the sequence shown in the figure. The embodiments of this application are not limited thereto.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A multi-target event prediction method performed by a computer device, the method comprising:
obtaining a historical behavior code sequence according to a historical behavior data sequence of a target object;
generating, for each of a plurality of prediction targets, historical feature data of the target object associated with the prediction target according to correlations between the historical behavior code sequence and the prediction target;
receiving, from a terminal, a request for predicting an event associated with the target object, the request including event information of the predicted event;
obtaining, according to the event information of the predicted event and the historical feature data of the target object corresponding to the plurality of prediction targets, prediction results of the predicted event associated with the target object under the plurality of prediction targets; and
returning the prediction results of the predicted event associated with the target object to the terminal.

2. The method according to claim 1, wherein the generating, for each of a plurality of prediction targets, historical feature data of the target object associated with the prediction target according to correlations between the historical behavior code sequence and the prediction target comprises:
obtaining operation behaviors of the target object corresponding to the historical behavior code sequence;
obtaining, for each of the plurality of prediction targets, relevance metrics respectively between the operation behaviors and the prediction target; and
weighting historical behavior codes in the historical behavior code sequence according to the relevance metrics between the operation behaviors and the prediction target, to obtain the historical feature data of the target object associated with the prediction target.

3. The method according to claim 2, wherein the weighting historical behavior codes in the historical behavior code sequence according to the relevance metrics between the operation behaviors and the prediction target, to obtain the historical feature data of the target object associated with the prediction target comprises:
obtaining similarities between the historical behavior codes and a coded representation corresponding to the event information;
determining, according to the relevance metrics and the similarities corresponding to the historical behavior codes, weight parameters corresponding to the historical behavior codes; and
weighting the historical behavior codes according to the corresponding weight parameters, to obtain the historical feature data corresponding to the prediction target.

4. The method according to claim 1, wherein the obtaining, according to the event information of the predicted event and the historical feature data of the target object corresponding to the plurality of prediction targets, prediction results of the predicted event associated with the target object under the plurality of prediction targets comprises:
extracting, on the basis of the event information, event feature data corresponding to the prediction targets; and
obtaining, for each prediction target, a prediction result of the predicted event associated with the target object according to the historical feature data and the event feature data corresponding to the prediction target.

5. The method according to claim 1, wherein the obtaining a historical behavior code sequence according to a historical behavior data sequence of a target object comprises:
obtaining a historical behavior embedding sequence according to the historical behavior data sequence; and
coding the historical behavior embedding sequence to obtain the historical behavior code sequence.

6. The method according to claim 5, wherein one historical behavior embedding in the historical behavior embedding sequence is an embedding representation corresponding to one piece of historical behavior data in the historical behavior data sequence.

7. The method according to claim 1, wherein the event information comprises item-associated information, user-associated information and scenario-associated information of the predicted event.

8. The method according to claim 1, wherein the prediction results of the predicted event comprise a click-through rate, a click value rate and a purchase quantity.

9. A computer device, comprising a processor and a memory, the memory storing at least one instruction that, when executed by the processor, causes the computer device to implement a multi-target event prediction method including:
obtaining a historical behavior code sequence according to a historical behavior data sequence of a target object;
generating, for each of a plurality of prediction targets, historical feature data of the target object associated with the prediction target according to correlations between the historical behavior code sequence and the prediction target;
receiving, from a terminal, a request for predicting an event associated with the target object, the request including event information of the predicted event;
obtaining, according to the event information of the predicted event and the historical feature data of the target object corresponding to the plurality of prediction targets, prediction results of the predicted event associated with the target object under the plurality of prediction targets; and
returning the prediction results of the predicted event associated with the target object to the terminal.

10. The computer device according to claim 9, wherein the generating, for each of a plurality of prediction targets, historical feature data of the target object associated with the prediction target according to correlations between the historical behavior code sequence and the prediction target comprises:
obtaining operation behaviors of the target object corresponding to the historical behavior code sequence;
obtaining, for each of the plurality of prediction targets, relevance metrics respectively between the operation behaviors and the prediction target; and
weighting historical behavior codes in the historical behavior code sequence according to the relevance metrics between the operation behaviors and the prediction target, to obtain the historical feature data of the target object associated with the prediction target.

11. The computer device according to claim 10, wherein the weighting historical behavior codes in the historical behavior code sequence according to the relevance metrics between the operation behaviors and the prediction target, to obtain the historical feature data of the target object associated with the prediction target comprises:
obtaining similarities between the historical behavior codes and a coded representation corresponding to the event information;
determining, according to the relevance metrics and the similarities corresponding to the historical behavior codes, weight parameters corresponding to the historical behavior codes; and
weighting the historical behavior codes according to the corresponding weight parameters, to obtain the historical feature data corresponding to the prediction target.

12. The computer device according to claim 9, wherein the obtaining, according to the event information of the predicted event and the historical feature data of the target object corresponding to the plurality of prediction targets, prediction results of the predicted event associated with the target object under the plurality of prediction targets comprises:
extracting, on the basis of the event information, event feature data corresponding to the prediction targets; and
obtaining, for each prediction target, a prediction result of the predicted event associated with the target object according to the historical feature data and the event feature data corresponding to the prediction target.

13. The computer device according to claim 9, wherein the obtaining a historical behavior code sequence according to a historical behavior data sequence of a target object comprises:
obtaining a historical behavior embedding sequence according to the historical behavior data sequence; and
coding the historical behavior embedding sequence to obtain the historical behavior code sequence.

14. The computer device according to claim 13, wherein one historical behavior embedding in the historical behavior embedding sequence is an embedding representation corresponding to one piece of historical behavior data in the historical behavior data sequence.

15. The computer device according to claim 9, wherein the event information comprises item-associated information, user-associated information and scenario-associated information of the predicted event.

16. The computer device according to claim 9, wherein the prediction results of the predicted event comprise a click-through rate, a click value rate and a purchase quantity.

17. A non-transitory computer-readable storage medium, storing at least one instruction, and the at least one instruction, when executed by a processor of a computer device, causing the computer device to implement a multi-target event prediction method including:
obtaining a historical behavior code sequence according to a historical behavior data sequence of a target object;
generating, for each of a plurality of prediction targets, historical feature data of the target object associated with the prediction target according to correlations between the historical behavior code sequence and the prediction target;
receiving, from a terminal, a request for predicting an event associated with the target object, the request including event information of the predicted event;
obtaining, according to the event information of the predicted event and the historical feature data of the target object corresponding to the plurality of prediction targets, prediction results of the predicted event associated with the target object under the plurality of prediction targets; and
returning the prediction results of the predicted event associated with the target object to the terminal.

18. The non-transitory computer-readable storage medium according to claim 17, wherein the generating, for each of a plurality of prediction targets, historical feature data of the target object associated with the prediction target according to correlations between the historical behavior code sequence and the prediction target comprises:
obtaining operation behaviors of the target object corresponding to the historical behavior code sequence;
obtaining, for each of the plurality of prediction targets, relevance metrics respectively between the operation behaviors and the prediction target; and
weighting historical behavior codes in the historical behavior code sequence according to the relevance metrics between the operation behaviors and the prediction target, to obtain the historical feature data of the target object associated with the prediction target.

19. The non-transitory computer-readable storage medium according to claim 17, wherein the obtaining, according to the event information of the predicted event and the historical feature data of the target object corresponding to the plurality of prediction targets, prediction results of the predicted event associated with the target object under the plurality of prediction targets comprises:
extracting, on the basis of the event information, event feature data corresponding to the prediction targets; and
obtaining, for each prediction target, a prediction result of the predicted event associated with the target object according to the historical feature data and the event feature data corresponding to the prediction target.

20. The non-transitory computer-readable storage medium according to claim 17, wherein the event information comprises item-associated information, user-associated information and scenario-associated information of the predicted event. multi-target event prediction method
